(19) United States
(12) Patent Application Publication
(10) Pub. No.: US 2017/0298250 A1
(43) Pub. Date: Oct. 19, 2017

(54) LIQUID COATING COMPOSITIONS, PROCESSES FOR PRODUCTION THEREOF AND USE THEREOF

(71) Applicants: Ralf ANSELMANN, Luedinghausen (DE); Markus HALLACK, Schermbeck (DE); Arne HOPPE, Essen (DE); Sonja MERKULOV, Marl (DE); Holger PFEIFER, Hanau (DE); Gerhard RENNER, Stockstadt am Rhein (DE)

(72) Inventors: Ralf ANSELMANN, Luedinghausen (DE); Markus HALLACK, Schermbeck (DE); Arne HOPPE, Essen (DE); Sonja MERKULOV, Marl (DE); Holger PFEIFER, Hanau (DE); Gerhard RENNER, Stockstadt am Rhein (DE)

(73) Assignee: Evonik Degussa GmbH, Essen (DE)

(21) Appl. No.: 15/510,282

(22) PCT Filed: Aug. 25, 2015
(86) PCT No.: PCT/EP2015/069394

§ 371 Date: Mar. 10, 2017

(30) Foreign Application Priority Data
Sep. 12, 2014 (DE) 10 2014 218 292.1

(51) Int. Cl. C09D 183/04; C09D 7/12; B05D 3/00; C09D 7/00; C09D 5/00; C08K 3/22

(52) U.S. Cl. CPC C09D 183/04; C09D 7/001; C09D 7/1216; C09D 7/1233; C09D 5/00; B05D 3/007; C08K 3/22; C08K 2003/2248; C08K 2003/2262; C08K 2003/2265

(57) ABSTRACT

The present invention relates to a liquid coating composition comprising i) at least one inorganic binder of the generic formula SiₐR¹_{b}O_{c}(OR²)_{d} with a≧2, b≧0, c≧1, d≧5 and R¹ and R²=organic radical, ii) at least one solvent and iii) at least one oxide pigment which, after addition of a mixture consisting of 15 ml of 1 M oxalic acid and 15 ml of 20% aqueous hydrochloric acid, based on 1 g of substance, under standard conditions, leads to a temperature rise of at least 4° C., to processes for preparation thereof and to the use thereof.

The invention relates to a liquid coating composition for the production of optically dense, thermally stable, nonconductive coatings, to processes for production thereof and to the use thereof, especially to the use thereof for production of thermally stable, nonconductive coatings.

Optically dense, nonconductive coatings are essential for many applications in semiconductor technology. Especially for the production of displays, optically dense and nonconductive coating compositions are required, in order to frame the edge of the display, protect electronic components from light and/or serve for pixel separation of the colour filters. The coating which is producible from the coating compositions and achieves the above objects—since they often lead to black coatings—is referred to as black matrix. However, it can in principle have any desired colour. Preferably, black matrices, however, are black or white.

The prior art discloses various processes for producing black matrices. For example, it is possible to produce black matrices by deposition of chromium, especially via sputtering (EP 0 740 183 A1). However, this method has the disadvantage that corresponding processes are very complex in apparatus terms and require large constructions, and integration into processes for producing displays is very complex. A further disadvantage of the use of chromium is that it is a heavy metal and hence environmentally harmful, and is very costly to dispose of.

Another means of producing black matrices uses solutions comprising dissolved organic dyes (EP 0 740 183 A1). However, these coating compositions are unsuitable for achievement of coatings having a high colour depth and homogeneous colour distribution. Black coating compositions in particular can be produced with these solutions, since there are no organic dyes to date that lead to deep black coatings. For this reason, mixtures of different dyes in solution are often used, but these have the disadvantage of leading to inhomogeneous colours. Furthermore, corresponding coatings are also incapable of withstanding temperatures as often used in display production. For this reason, solutions comprising organic dyes have not led to any commercial use to date in display production.

A third means of producing black matrices is based on the use of a coating composition comprising a binder and a pigment. Pigments used may preferably be carbon black (i.e. pigment black) or metal oxides, especially spinel colour pigments. Preference is given to spinel colour pigments, since the production of nonconductive coatings with pigment black in high concentrations is difficult, since it is necessary to prevent the resulting coatings from becoming conductive in the course of drying. In addition, pigment blacks and many other pigments can be dispersed only with difficulty, have a tendency to coagulate, which again has an adverse effect on the quality of the black matrix layer. Finally, spinel pigments are very thermally stable and can—unlike pigment blacks and non-spinel pigments—in some cases even not be formed until they are within the cured coatings (Silva et al., Journal of Magnetism and Magnetic Materials, 272-276 (2004) e 1851-e1853). The colour pigments may also be surface-treated (cf., for example, DE 40 14 928 C1 and U.S. Pat. No. 6,136,083 A).

However, coating compositions consisting exclusively of at least one binder and at least one pigment for black matrices (powder coatings) have the disadvantage that they lead to very inhomogeneous thick coatings and additionally cannot be structured efficiently. For this reason, binder-containing coating compositions advantageously also comprise at least one solvent.

The prior art discloses organic binders for solvent-containing coating compositions for black matrices. For instance, U.S. Pat. No. 5,780,201 A discloses solvent-containing coating compositions comprising (as well as a dye) a polyimide resin and a pigment based on a mixed metal oxide. U.S. Pat. No. 5,814,434 A also discloses a coating composition suitable for production of black matrices, comprising a mixed oxide of at least two metals and a binder, which is preferably an inorganic binder. However, the use of organic binders has the disadvantage that the corresponding coating compositions can be converted only at relatively low temperatures, and the coatings produced therewith cannot be exposed to high temperatures since they, for example, decompose or become discoloured or conductive. Since high temperatures are typically required at other sites in display production, especially in the production of touchscreens, a black matrix based on an organic binder has to be bonded to an additional carrier, especially an additional glass. This is disadvantageous because of the higher thickness of the display, the higher weight of the display and additionally particularly because of the reduced battery performance and increased power requirement (since the additional layer absorbs the radiation from the display and a higher power is required to achieve a representation of equal brightness) of the display. In addition, it makes the production process more complex.

U.S. Pat. No. 5,814,434 A discloses inorganic alternatives suitable in principle for higher temperatures. However, the proposed solutions of a glass frit having a low melting point, organosilicon compounds such as ethoxy silicon dioxide and organolead compounds are suitable only for powder coatings and therefore give inhomogeneous thick coatings unsuitable for production of finely structured black matrices. The inorganic-organic mixed systems likewise disclosed in U.S. Pat. No. 5,814,434 A are again suitable only for curing at comparatively low temperature.

DE 2 141 169 A1 discloses protective coating materials including a siloxane, organic solubilizers and 10%-70% of oxides of a refractory filler, wherein the refractory oxides used as extenders may be spinels inter alia.

DE 44 17 405 A1 discloses coating compositions producible from hydrolysable silanes, which comprise water and solvents and may optionally further comprise a fine-scale filler, which may especially also comprise oxides of metals, especially spinels, and carbon black. DE 103 61 632 A1 discloses a process for producing a substrate coated with a carbonaceous coating, in which a substrate is coated with a carbon polymorph, an organic-inorganic binder, which may be a hydrolysate or a precondensate of one or more silanes, and solid particles, which may be metal oxides or metal oxide hydrates (including spinels).

In spite of their many advantages, oxide pigments and mixed oxide pigments (including spinel pigments), however, are generally disadvantageous, since it is not possible to produce particularly finely structured coatings therewith. Particularly finely structured coatings can be produced for other coating systems via etching processes in which coatings applied over part or all of the area are treated with removal of a portion or a constituent of the coating applied to produce a particularly fine structure. However, no such process exists as yet for coating compositions for black matrices comprising mixed oxide pigments, including spinel pigments. Thus, no route to particularly finely structured black matrices based on these pigments has been disclosed to date.

The problem addressed by the present invention is thus that of overcoming the disadvantages of the prior art and providing coating compositions suitable for the production of nonconductive layers, especially for the production of black matrices, which lead to good, particularly finely structurable nonconductive layers that are resistant to high temperatures as well, especially black matrices. More particularly, it is an object of the present invention to provide a coating composition with which it is possible to produce coatings which can be structured especially with weak acids or weak acid mixtures.

This problem is solved by the inventive liquid coating composition comprising i) at least one inorganic binder of the generic formula SiₐR¹_{b}O_{c}(OR²)_{d} with a≦2, b≦0, c≦1, d≦5 and R¹ and R²=organic radical, ii) at least one solvent and iii) at least one oxide pigment which, after addition of a mixture consisting of 15 ml of 1 M oxalic acid and 15 ml of 20% aqueous hydrochloric acid (HCl), based on 1 g of substance, under standard conditions (SATP: 25° C., 1.013 bar), leads to a temperature rise of at least 4° C.

The inventive coating compositions can be structured very efficiently. In addition, the inventive coating compositions have the advantage that they can be very finely structured successfully even with weak acids or weak acid mixtures, and hence there is no requirement for etching via, for example, highly technical vacuum processes (as, for example, in the case of dry etching) or with strong acids or acids that cause a high degree of damage to health or the environment (such as hydrofluoric acid).

The exothermic reaction after the addition of the mixture, having a volume of 30 ml, of 15 ml of 1 M oxalic acid and 15 ml of 20% aqueous hydrochloric acid (HCl) to 1 g of oxide pigment, which has the particular feature of an elevated temperature of at least 29° C. 60 seconds after the addition under SATP and subsequent stirring at 200 rpm for the oxide pigments usable in accordance with the invention, in contrast to other oxide pigments, is a pointer to reactivity and hence corresponding suitability of the respective mixed oxide pigment.

A “liquid” coating composition is additionally understood in the present context to mean a composition in liquid form under standard conditions (SATP: 25° C., 1.013 bar).

The coating composition includes at least one oxide pigment that exhibits the described property of leading to a temperature increase. Oxide pigments may be i) pigments based on an oxide of an oxidation state of a (semi)metal, ii) pigments based on mixed oxides of a (semi)metal in more than one oxidation state (mixed-valency oxides of a (semi)metal, for example iron oxide Fe₃O₄) and iii) pigments based on mixed oxides (mixed-phase oxide pigments) of at least two (semi)metals each in one or more oxidation states. The term “(semi)metals” encompasses metals and semimetals in equal measure.

Preferably, the at least one oxide pigment is a pigment based on a mixed oxide of a (semi)metal in more than one oxidation state (e.g. iron oxide Fe₃O₄) or a pigment based on mixed oxides (i.e. a mixed-phase oxide pigment) of at least two (semi)metals each in one or more oxidation states. Further preferably, the pigment is a pigment based on mixed oxides of at least two (semi)metals, each of which may again be in one or more oxidation states. Most preferably, the pigment is a pigment based on mixed oxides of at least two metals, of which at least two metals are in different oxidation states (mixed-valency oxides). Corresponding compounds are oxides and/or mixed oxides and may have, for example, a spinel structure or an inverse spinel structure (and hence be monophasic mixed phase pigments), or else take the form of a mixture of different crystal phases.

Particularly good results are achieved with pigments which are mixed iron-manganese oxides. Particular preference is further given to the copper oxide-containing mixed iron-manganese oxides, with which very particularly good results can be achieved. Corresponding “mixed oxide” pigments are understood to mean both monophasic and polyphasic mixed crystal oxides.

Very particularly preferred copper oxide-containing mixed iron-manganese oxides are those obtainable via calcination of manganese(II) oxide (MnO), manganese(III) oxide (Mn₂O₃), iron(II) oxide (FeO), iron(III) oxide (Fe₂O₃) and copper(II) oxide (CuO). Corresponding mixed oxides are also referred to by the Colour Index (C.I. for short) as “Pigment Black 26”. C.I. is a reference work that has existed since 1925 for all commonly used colourants and dye-based chemicals and is a standard work in the field of pigment and dye chemistry. The Colour Index is published by the British Society of Dyers and Colourists and the American Association of Textile Chemists and Colorists.

Corresponding particularly preferred pigments are obtainable under the Black 444 name from The Shepherd Color Company, USA, Daipyroxide Black 9550 from Dainichiseika Color & Chemicals Mfg. Co., Ltd., Japan, Spinel Black 47400 from Kremer Pigmente GmbH and Co. KG, Germany and PS 24-3060 PK from Ferro GmbH, Germany. Even though these particularly preferred pigments are referred to as manganese-iron black spinels, it is not certain that these pigments have a spinel structure exclusively or at all.

In addition to the oxide pigments mentioned, it is also possible for further colour pigments to be present in the composition, especially titanium dioxide, zinc white, spinel blue, lithopone, barium sulphate, zinc oxide, calcium carbonate, cristobalite or kaolin. Preferably, the inventive compositions, however, contain only the oxide pigments.

In addition, the composition, for attainment of coatings having particularly good nonconductivity, is preferably carbon-free, meaning that it does not contain any proportions of carbon polymorphs such as carbon black, graphite, activated carbon, carbon dust, fullerenes, graphene and the like.

The proportion of oxide pigments having the property described in the composition is preferably, based on the total mass of the composition, 10% to 50%, further preferably 15% to 40% and more preferably 15% to 35% by weight.

The inventive coating compositions, as well as the desired advantages, surprisingly additionally also have a particularly high optical density.

The at least one inorganic binder—formally an oxyalkoxysilane compound or an alkylated oxyalkoxysilane compound—is a condensation product of alkoxysilanes and optionally alkylated alkoxysilanes and can be prepared therefrom under acid or acid ester catalysis. Reactants used may preferably be alkoxysilanes of the generic formula Si(OR²)₄ with R²=organic radical and alkylated alkoxysilanes of the generic formula SiR¹(OR²)₃ with R¹ and R²=organic radical. The corresponding reaction can be conducted particularly efficiently in water. The reaction can be conducted particularly efficiently with phosphoric esters, preferably with monomethyl phosphates. Reactants used may preferably be alkoxysilanes of the generic formula Si(OR²)₄ and alkylated alkoxysilanes SiR¹(OR²)₃ with R¹ or R²=—CH₃, —CH₂CH₃, —CH₂CH₂CH₃, —CH(CH₃)₂. Even though the reaction is conducted in the presence of water, it is generally the case that, after completion of the reaction, i.e. after formation of the binder, water is present only in very small proportions of typically <5% by weight, especially <2% by weight, further especially <1% by weight, based on the total mass of the coating composition.

The resulting binder of the generic formula SiₐR¹_{b}O_{c}(OR²)_{d} preferably correspondingly has R¹ and R² radicals=—CH₃, —CH₂CH₃, —CH₂CH₂CH₃, —CH(CH₃)₂, preferably R¹ and R²=—CH₃ and/or —CH₂CH₃.

Particularly good coatings which display particularly low brittleness can be achieved when a mixture of SiCH₃(OCH₂CH₃)₃ and Si(OCH₂CH₃)₄ is used. The resulting binders correspondingly have the R¹=—CH₃ and R² radicals=—CH₂CH₃.

Of particularly good suitability for production of finely structurable black matrices having particularly homogeneous layers with low surface roughnesses are coating compositions comprising corresponding binders with a=5 to 150, preferably a=20 to 100, preferably a=30 to 80, silicon atoms.

The maximum value for the sum of b+d, especially in the case of low values of a, is close to 4−a. The value of c is at least 1 and is related to the values of a, b and d by the relationship 4−a=b+2·c+d. Preferably, the ratio of c to a for achievement of particularly good properties of the resulting layer is on average 1.1 to 2.0, further preferably 1.15 to 1.8, most preferably 1.2 to 1.5.

Preferably, the coating compositions of the invention are additionally essentially free of organic binders (i.e. the proportion of organic binder, based on the total mass of binder, is less than or equal to 5% by weight, preferably less than or equal to 2% by weight, further preferably 0% by weight), since they have the great advantage in that case of being usable for thermal steps at up to 800° C.

The inorganic binder, for achievement of particularly good results, is present preferably in proportions of 5% to 75% by weight, further preferably 10% to 45% by weight, based on the total mass of the coating.

The composition additionally comprises at least one solvent. In principle, both organic solvents and water are conceivable as solvents. However, particularly good coatings result when the at least one solvent is an organic solvent or a mixture of organic solvents. Preferably, the organic solvent is an alcohol, an alkyl ester, an alkoxy alcohol and/or an alkoxyalkyl ester. Most preferably, the at least one solvent is 1-methoxy-2-propanol, ethyl lactate, butyl acetate, ethyl benzoate, propylene glycol monomethyl ether acetate, tri(ethylene glycol) monoethyl ether (ethyl triglycol, TGEE), ethanol, isopropanol and/or butanol.

Generally, the proportion of the solvent(s) is preferably 20%-80% and further preferably 35%-70% by weight, based on the total mass of the coating.

The composition may additionally include, as well as the essential constituents of inorganic binder, solvent and oxide pigment, further additions and additives as well. For instance, the composition, as well as the at least one oxide pigment, may include further pigments or dyes. Preferably, the inventive composition, however, comprises only oxide pigments as pigment constituents. In addition, the composition may include at least one wetting additive, dispersing additive and/or levelling additive as additive for attainment of positive properties. Particularly preferred additives are additives based on urethane copolymers or polyethers modified, for example, with siloxanes. Particularly preferred additives are the commercially available products o having the TEGO Dispers 656 and TEGO Glide 450 names (each from Evonik Goldschmidt GmbH) and BYK 111 name (from Byk Chemie GmbH). It is additionally possible to add particulate SiOₓ as filler to the inventive coating composition for achievement of advantageous properties.

Preferably, the composition used in the process according to the invention, for achievement of particularly good coatability, printability and sprayability, has a viscosity of 1 mPa·s to 10 Pa·s, especially 1 mPa·s to 100 mPa·s, determined to DIN 53019 Part 1 to 2 and measured at 20° C. Corresponding viscosities can be established by adding polymers, cellulose derivatives, or SiO₂ available under the Aerosil trade name, and especially preferably by means of PMMA, polyvinyl alcohol, urethane thickeners or polyacrylate thickeners.

Additions and additives, if they are present at all, are used typically in proportions of not more than 10%, preferably not more than 3%, by weight, based on the total mass of the composition.

The invention further relates to a process for producing the inventive aqueous coating compositions, comprising the steps of
admixing at least one alkoxysilane of the generic formula Si(OR²)₄ and optionally an alkylated alkoxysilane of the generic formula SiR¹(OR²)₃ with R¹ and R²=organic radical in aqueous solution with an acid or acid ester,
reacting to give the compounds of the generic formula SiₐR¹_{b}O_{c}(OR²)_{d} and
admixing
   with at least one oxide pigment which, after addition to a mixture of 15 ml of 1 M oxalic acid and 15 ml of 20% aqueous hydrochloric acid based on 1 g of substance, under standard conditions (SATP: 25° C., 1.013 bar), especially after 60 s, leads to a temperature increase of at least 4° C. and
   at least one solvent.

The compound of the generic formula SiₐR¹_{b}O_{c}(OR²)_{d} is a condensation product of the alkoxysilane and optionally of the alkylated alkoxysilane. The reaction can be catalysed particularly efficiently with acids or acid esters selected from hydrochloric acid, phosphoric acid, nitric acid, organic acids and esters thereof. Suitable commercial products are, for example, Hordaphos CCMS from Clariant. Reactants used are alkoxysilanes of the generic formula Si(OR²)₄ with R²=organic radical and optionally alkylated alkoxysilanes of the generic formula SiR¹(OR²)₃ with R¹ and R²=organic radical. Reactants used may preferably be alkoxysilanes of the generic formula Si(OR²)₄ and alkylated alkoxysilanes SiR¹(OR²)₃ with R¹ or R²=—CH₃, —CH₂CH₃, —CH₂CH₂CH₃, —CH(CH₃)₂.

The resulting binder of the generic formula SiₐR¹_{b}O_{c}(OR²)_{d} preferably correspondingly has R¹ and R² radicals=—CH₃, —CH₂CH₃, —CH₂CH₂CH₃, —CH(CH₃)₂, preferably R¹ and R²=—CH₃ and/or —CH₂CH₃.

Particularly good coatings which display particularly low brittleness can be achieved when a mixture of SiCH₃(OCH₂CH₃)₃ and Si(OCH₂CH₃)₄ is used. The resulting binders correspondingly have the R¹=—CH₃ and R²=—CH₂CH₃ radicals.

Preferably, after the reaction and before the admixing with the at least one oxide pigment, the gelated solution, to achieve coating compositions of particularly good suitability in terms of surface roughness, hardness, homogeneity and coatability, is admixed with a solvent.

Particularly good results can be achieved when the solvent is an alcohol, an alkyl ester (especially an acetate or a lactate), an alkoxy alcohol and/or an alkoxyalkyl ester. Most preferably, the solvent is a solvent selected from the group consisting of 1-methoxy-2-propanol, ethyl lactate, butyl acetate, ethyl benzoate, propylene glycol monomethyl ether acetate, tri(ethylene glycol) monoethyl ether, ethanol, isopropanol and butanol, since particularly smooth and homogeneous layers can be produced with these additions.

The solvent(s) is/are preferably added to the coating in proportions of 20%-80% and further preferably 35%-70% by weight, based on the total mass of the coating.

The inorganic binder, for achievement of particularly good results, is additionally preferably added in proportions of 5% to 75% by weight, further preferably 10% to 45% by weight, based on the total mass of the coating.

In addition, in the process according to the invention, at least one oxide pigment which, after addition to a mixture of 15 ml of 1 M oxalic acid and 50 ml of 20% aqueous hydrochloric acid based on 1 g of substance, under standard conditions (SATP: 25° C., 1.013 bar), leads to a temperature rise of at least 4° C. is added.

Oxide pigments may be i) pigments based on an oxide of an oxidation state of a (semi)metal, ii) pigments based on mixed oxides of a (semi)metal in more than one oxidation state (mixed-valency oxides of a (semi)metal, for example iron oxide Fe₃O₄) and iii) pigments based on mixed oxides (mixed-phase oxide pigments) of at least two (semi)metals each in one or more oxidation states. The term “(semi)metals” encompasses metals and semimetals in equal measure.

Preferably, the at least one oxide pigment is a pigment based on a mixed oxide of a (semi)metal in more than one oxidation state (e.g. iron oxide Fe₃O₄) or a pigment based on mixed oxides (i.e. a mixed-phase oxide pigment) of at least two (semi)metals each in one or more oxidation states. Further preferably, the pigment is a pigment based on mixed oxides of at least two (semi)metals, each of which may again be in one or more oxidation states. Most preferably, the pigment is a pigment based on mixed oxides of at least two metals, of which at least two metals are in different oxidation states (mixed-valency oxides). Corresponding compounds are oxides and/or mixed oxides and may have, for example, a spinel structure or an inverse spinel structure (and hence be monophasic mixed phase pigments), or else take the form of a mixture of different crystal phases.

Particularly good results are achieved with pigments which are mixed iron-manganese oxides. Particular preference is further given to the copper oxide-containing mixed iron-manganese oxides, with which very particularly good results can be achieved. Corresponding “mixed oxide” pigments are understood to mean both monophasic and polyphasic mixed crystal oxides.

Very particularly preferred copper oxide-containing mixed iron-manganese oxides are those obtainable via calcination of manganese(II) oxide (MnO), manganese(III) oxide (Mn₂O₃), iron(II) oxide (FeO), iron(III) oxide (Fe₂O₃) and copper(II) oxide (CuO). Corresponding mixed oxides are also referred to by the Colour Index (C.I. for short) as “Pigment Black 26”. C.I. is a reference work that has existed since 1925 for all commonly used colourants and dye-based chemicals and is a standard work in the field of pigment and dye chemistry. The Colour Index is published by the British Society of Dyers and Colourists and the American Association of Textile Chemists and Colorists.

Corresponding particularly preferred pigments are obtainable under the Black 444 name from The Shepherd Color Company, USA, Daipyroxide Black 9550 from Dainichiseika Color & Chemicals Mfg. Co., Ltd., Japan, Spinel Black 47400 from Kremer Pigmente GmbH and Co. KG, Germany and PS 24-3060 PK from Ferro GmbH, Germany. Even though these particularly preferred pigments are referred to as manganese-iron black spinels, it is not certain that these pigments have a spinel structure exclusively or at all.

In addition to the oxide pigments mentioned, it is also possible for further colour pigments to be added, especially titanium dioxide, zinc white, spinel blue, lithopone, barium sulphate, zinc oxide, calcium carbonate, cristobalite or kaolin. Preferably, however, only the oxide pigments are added to the inventive compositions.

In addition, for attainment of coatings having particularly good nonconductivity, preferably no carbon component is added to the composition, meaning that no proportions of carbon polymorphs such as carbon black, graphite, activated carbon, carbon dust, fullerenes, graphene and the like are added thereto.

The addition of oxide pigments having the property described in the composition is preferably effected, based on the total mass of the composition, in proportions of 10% to 50%, further preferably 15% to 40% and more preferably 15% to 35% by weight.

As well as the essential constituents of inorganic binder, solvent and oxide pigment, further additions and additives may additionally be added to the composition too. For instance, as well as the at least one oxide pigment, further pigments or dyes may be added to the composition. Preferably, however, only oxide pigments as pigment constituents are added to the inventive composition. In addition, for attainment of positive properties, at least one wetting additive, dispersing additive and/or levelling additive may be added as additive to the composition. Particularly preferred additives are additives based on urethane copolymers or polyethers modified, for example, with siloxanes. Particularly preferred additives are the commercially available products having the TEGO Dispers 656 and TEGO Glide 450 names (each from Evonik Goldschmidt GmbH) and BYK 111 name (from Byk Chemie GmbH). It is additionally possible to add particulate SiOₓ as filler to the inventive coating composition for achievement of advantageous properties.

Preferably, the composition, for achievement of particularly good coatability, printability and sprayability, is adjusted to a viscosity of 1 mPa·s to 10 Pa·s, especially 1 mPa·s to 100 mPa·s, determined to DIN 53019 Part 1 to 2 and measured at 20° C. Corresponding viscosities can be established by adding polymers, cellulose derivatives, or SiO₂ available under the Aerosil trade name, and especially preferably by means of PMMA, polyvinyl alcohol, urethane thickeners or polyacrylate thickeners.

Additions and additives, if they are present at all, are used typically in proportions of not more than 10%, preferably not more than 3%, by weight, based on the total mass of the composition.

The present invention further provides for the use of the inventive coating compositions for production of nonconductive coatings, especially for production of black matrices.

The present invention further provides a process for producing a nonconductive coating on a substrate, in which a substrate is coated with an inventive liquid coating composition, optionally dried and then cured (“converted”).

The process according to the invention is particularly advantageously a coating process selected from printing processes (especially flexographic/gravure printing, inkjet printing—most preferably continuous, thermal or piezo inkjet printing, offset printing, digital offset printing and screen printing), spraying processes, spin-coating processes, dip-coating processes, and processes selected from meniscus coating, slit coating, slot-die coating and curtain coating. Most preferably, the process according to the invention is a printing process or spin-coating process. Especially suitable printing processes are inkjet and liquid toner processes (for example HP Indigo), since these processes are of particularly good suitability for a structured application of the printing material.

If the liquid coating composition is applied by spin-coating, this is preferably effected at speeds between 100 and 5000 rpm. Preferably, coating is first of all effected at a low spin speed of 100 to 1000 rpm over a period of 5 s to 30 s, and then the spin speed is increased once again to 1500 to 5000 rpm for a period of 10 s to 120 s.

The substrate which is used in the process according to the invention is especially a substrate selected from glass, silicon, silicon dioxide, a metal oxide or transition metal oxide, a metal or a polymeric material, especially PI, PEN, PEEK, PC or PET.

After the liquid coating composition has been applied, the solvent is preferably removed by drying. In addition, this prevents cracking of the layer in the later curing step. The latter is preferably effected at standard pressure by thermal means at temperatures between 50 and 150° C. within drying times between 30 s and one hour.

The curing is preferably effected over periods of 5 minutes to 1 hour at temperatures of 200° C. to 800° C.

### EXAMPLES

### Example 1

### Making Up the Sol-Gel Matrix

Tetraethoxysilane (TEOS) (15.44 wt %) and methyltriethoxysilane (MTES) (66.18 wt %) are mixed
Subsequently added thereto are demineralized H₂O (9.18 wt %) and Hordaphos CCMS phosphoric ester (0.02 wt %)
The mixture is stirred on a stirrer plate overnight
Then demineralized H₂O (9.18 wt %) is added again

### Example 2

### Production of the Dispersion

The 1-methoxy-2-propanol solvent (57.85 wt %) is initially charged, in order to dilute the sol-gel mixture to the suitable solids concentration
Then 15.03 wt % of the sol-gel mixture is added
The TEGO Dispers 710 dispersing and wetting additive (2.10 wt %) is added

Lastly, the pigment Spinel Black 47400 “deepest black (Fe,Mn)(Fe,Mn)₂O₄” from Kremer Pigmente GmbH & Co. KG is added (amount 25.02 wt %)
For the dispersion by means of an agitated mixer (Scandex), about 30 g of zirconium oxide grinding beads of size 0.4 to 0.6 mm are added
The dispersion mixture is dispersed for at least 2 hours, but better 10 hours, in the agitated mixer
After the dispersion, the grinding beads are removed by sedimentation or filtering

### Example 3

### Substrate Coating

As substrates to be coated, glass substrates are used
Prior to coating, the glass substrates are cleaned with organic solvent (isopropanol), rinsed with DI water and then blown dry with nitrogen
The dispersion is applied by means of a spin-coating method with the following parameters: 10 sec at 500 rpm, then 30 sec at 2000 rpm
The curing is preceded by a prebake step, in order to gradually remove the solvent and prevent cracking of the layer (10 min at 100° C. on the hotplate)
After the prebake, the temperature is increased gradually (within about 10-15 min) to 350° C.
The curing takes place on the hotplate at 350° C. for one hour.

1. A liquid coating composition, comprising:
i) at least one inorganic binder of the generic formula SiₐR¹_{b}O_{c}(OR²)_{d} with a≧2, b≧0, c≧1, d≧5 and R¹ and R²=organic radical,
ii) at least one solvent, and
iii) at least one oxide pigment which, after addition of a mixture consisting of 15 ml of 1 M oxalic acid and 15 ml of 20% aqueous hydrochloric acid based on 1 g of substance, under standard conditions, leads to a temperature rise of at least 4° C.

2. The composition according to claim 1,
wherein the pigment is based on a mixed oxide of a (semi)metal in more than one oxidation state and/or a pigment based on at least two mixed oxides of at least two (semi)metals each in one or more oxidation states.

3. The composition according to claim 2,
wherein said pigment is a mixed iron-manganese oxide.

4. The composition according to claim 3,
wherein said pigment is a copper-containing mixed iron-manganese oxide.

5. The composition according to claim 4,
wherein the mixed iron-manganese oxide is obtainable via a calcination of manganese(II) oxide, manganese(III) oxide, iron(II) oxide and iron(III) oxide and copper(II) oxide.

6. The composition according to claim 5,
wherein the pigment is assigned to the group of pigments having the Colour Index designation Pigment Black 26.

7. The composition according to claim 1, wherein a proportion of oxide pigment, based on the total mass of the composition, is 10%-50% by weight.

8. The composition according to claim 1, wherein
R¹ and R²=—CH₃, —CH₂CH₃, —CH₂CH₂CH₃, —CH(CH₃)₂.

9. The composition according to claim 1, wherein the inorganic binder of the generic formula SiₐR¹_{b}O_{c}(OR²)_{d} has been prepared from a mixture of SiCH₃(OCH₂CH₃)₃ and Si(OCH₂CH₃)₄.

10. The composition according to claim 1, wherein the at least one solvent is selected from the group consisting of an alcohol, an alkyl ester, an alkoxy alcohol, an alkoxyalkyl ester and mixtures thereof.

11. The composition according to claim 10, wherein the at least one solvent is selected from the group consisting of 1-methoxy-2-propanol, ethyl lactate, butyl acetate, ethyl benzoate, propylene glycol monomethyl ether acetate, tri(ethylene glycol) monoethyl ether, ethanol, isopropanol and butanol.

12. A process for producing a coating composition according to claim 1, said process comprising:
admixing at least one alkoxysilane of the generic formula Si(OR²)₄ and optionally an alkylated alkoxysilane of the generic formula SiR¹(OR²)₃ with R¹ and R²=organic radical in aqueous solution with an acid or acid ester, to obtain a mixture,
reacting said mixture to give a compound of the generic formula SiₐR¹_{b}O_{c}(OR²)_{d}, and
admixing said compound
with at least one oxide pigment which, after addition to a mixture of 15 ml of 1 M oxalic acid and 15 ml of 20% aqueous hydrochloric acid based on 1 g of substance, under standard conditions, leads to a temperature rise of at least 4° C., and
at least one solvent.

13. A method for production of a non-conductive coating, said method comprising:
contacting a substrate with the coating composition of claim 1, to obtain a coated substrate.

14. The process according to claim 13, further comprising:
drying and then curing of the coated substrate.

15. A non-conductive coating obtained by the method of claim 13.

16. A black matrix obtained by the method of claim 13.
